(19) United States
(12) Patent Application Publication
(10) Pub. No.: US 2014/0164295 A1
(43) Pub. Date: Jun. 12, 2014

(54) P Score Method

(71) Applicant: Eric LeRoy Nelson, Sacramento, CA (US)

(72) Inventor: Eric LeRoy Nelson, Sacramento, CA (US)

(21) Appl. No.: 13/709,013

(22) Filed: Dec. 9, 2012

(51) Int. Cl. G06Q 99/00

(52) U.S. Cl. CPC G06Q 99/00
USPC 705/500

(57) ABSTRACT

Performance Scores can be used to identify police officers whose domestic violence investigations are habitually insufficient, those types of investigations being routinely rejected by prosecutors. By identifying specific areas of investigative weakness, per officers, supervisors are able to design specific remediation training that responds to areas of identified deficiency. P Score data can be used to track officer performance during periods of improvement. Aggregated P Score data can be used to assess entire police agencies for the sufficiency of their response to domestic violence crime. The P Score method fills a vacuum that currently exists in criminal justice, because presently no quantitative method exists to identify problem areas of individual officer's investigative habits.

### CROSS-REFERENCES TO RELATED APPLICATIONS

Not applicable

### STATEMENT REGARDING FEDERALLY SPONSORED RESEARCH OR DEVELOPMENT

Not applicable

### REFERENCE TO A SEQUENCE LISTING, TABLE, COMPUTER PROGRAM LISTING, OR COMPACT DISK APPENDIX

Not applicable

### BACKGROUND OF THE INVENTION

This invention responds to an unmet practical need in criminal justice. The background section of this application reviews four interconnected conditions that together frame the problem that is solved by this invention.

Background Condition #1:

Low rates of prosecution of domestic violence (DV) crime.

When prosecutors decide whether to file criminal charges for domestic violence crime against a suspect identified by police, their primary source of information is the written report produced by the first responding police officer (Hinds 1993:87; Miller 1993:1-2; Levie and Ballard 1978:13). Unfortunately, as Garner & Maxwell's meta-analysis demonstrates, after reading those reports prosecutors reject two thirds of them (2009: Table 5). That means two out of three domestically violent people escape prosecution in the United States.

Background Condition #2:

Justice is denied to victims whose cases are not prosecuted.

What this means, in real human terms, is that many victims of domestic violence, including children who witness it,^{1, 2} do not receive justice—and more importantly, some of the protections of the State that would be afforded upon criminal conviction of the perpetrator³ are instead not given. Low rates of domestic violence prosecution is a preventable tragedy. ¹ In the article I am withholding until the patent has been granted, I establish, by analyzing U.S. Census Bureau data, that children are present in between 61-86% of the domestically violent homes.² Children exposed to DV may be more aggressive (Archer and Parker 1994), and more violent (Sharkey 2006), have more conduct disorders (Emery and O'Leary 1984; Jouriles, Barling, and O'Leary 1987), and they may grow up to be more violent adults (Carroll 1980). Girls who witness their mother battering a partner may be more aggressive themselves as adults (Murrell, Christoff, and Henning 2007), and they are more likely to become homeless adults (Browne and Bassuk 1997). Exposed boys are three times more likely to become violent adults (Dutton and Hart 1992).³ Some protections of the State could include a post-conviction sentencing order for the defendant to attend Alcoholics Anonymous meetings, a drug rehabilitation program, an anger management class, a parenting class, to submit to random drug and alcohol testing, to maintain employment, to pay child support, etc. Specific to children, Child Protective Services (CPS) could be ordered to inspect the home periodically, to insure the violence has not continued, that children are receiving adequate nutrition, are attending school, are receiving appropriate medical care, and if needed are provided with psychological counseling to deal with the violence they witnessed.

Background Condition #3:

Police agencies lack an academically sound, legally defensible method to identify police officers whose investigations routinely do not get prosecuted.

Unfortunately, only a small number of published studies have examined the relationship between police officer work habits and prosecutorial outcomes. A year long study of N=4,500 police officers showed more than half of all criminal convictions resulted from the work of just 8% of the officers, and more than half of all felony convictions were the work of 5.5% of the officers (National Institute of Law Enforcement and Criminal Justice, NILECJ 1977).

The National Institute of Justice replicated the NILECJ study (1982), identifying two subsets of officers: Those who routinely perform thorough investigative work, and those who don't; the former group being responsible for most case filings and criminal convictions, and the latter group generating mostly rejected cases.

An ethnography by Stanko (1981), who attended hundreds of case screenings, events where prosecutors decided whether to reject investigations or file criminal charges, showed most police investigations were rejected, being described by prosecutors as “garbage cases.”

The California State Attorney General has reported the problem of insufficient domestic violence investigation is not only is seen at the individual officer level, but also at the agency level as well (2005:54). The Attorney General found sometimes prosecutors will return an insufficient investigation for further work—if the officer works for an agency known to usually perform sufficient investigative work; those who don't are known to prosecutors, who don't bother returning rejected investigations to them.

Background Condition #4:

A best practices DV investigation model is known, but optional, and its rate of use is insufficient.

Until recently no scholar had specifically studied those optional components of a domestic violence investigation under the control of first responding police officers, and their relationship to prosecution of DV crime. I recently published the first study of that type (Nelson 2012). I examined six optional investigative techniques (OIT's), calculating their effect upon the odds of prosecution. Five non-temporal OITs were assessed together in a model, using logistic regression.⁴ The sixth variable, which is the time period between when an officer investigates the crime and when her/his report is transmitted to the prosecutor's office was assessed using survival analysis. They are: ⁴ χ²=63.10, p<0.000, Pseudo R²=0.142. Within the model: EPO β=0.628, OR=1.87, z=2.38, p<0.02; Photos β=0.471, OR=1.60, z=1.86, p<0.06; Arrest β=0.664, OR=1.94, z=2.56, p<0.01; Finding≧1 witnesses β=0.517, OR=1.68, z=1.89, p<0.06; Listing>1 charge β=1.34, OR=3.84, z=5.03, p<0.00. See Nelson (2012) for further.
(1) If an emergency protective order (EPO) was obtained, the odds of prosecution increase 87%.⁵ ⁵ Recall that when converting an Odds Ratio to Odds one must use: Odds=((OR−1)*10²). As an example, the OR for EPO is 1.87. To calculate odds we perform: Odds, EPO=((1.87−1)*10²)=87%.
(2) If photographs were obtained, the odds of prosecution increase 60%.
(3) If one or more witnesses were located, the odds of prosecution increases 68%.
(4) If the defendant was located and arrested, the odds of prosecution increase 94%.
(5) For each additional crime code section that is listed, the odds of prosecution increase 284%.
(6) Inspection of a survival analysis graph where the odds of prosecution are the ordinate and time is the abscissa demonstrates a nearly vertical slope immediately after the crime event. What that means is there is a rapid decrease in the likelihood of prosecution if there is any delay in submitting the officer's written report to the prosecutor's office. Thus, officers must complete their investigation and submit a written report the same day, before leaving.

Statement of the Problem: Only one in three domestic violence investigations result in criminal prosecution. Two thirds are rejected because, largely, officers failed to operationalize the six optional investigative techniques recently shown to have a major impact upon the odds of prosecution. However, even if use of the OIT's is mandated, there is currently no existing methodology to quantitatively and consistently assess the routine investigative habits of individual police officers, and also entire police agencies. Without the ability to evaluate officers in a quantitative manner, police supervisors or agencies can do little to enforce mandates, once they are established, because they lack defensible quantitative data upon which to base remediation, and discipline. Police supervisors and agencies need an academically and legally defensible method by which they can reliably identify routinely deficient officers, one who habitually under investigate domestic violence crime.

### BRIEF SUMMARY OF THE INVENTION

Using the OIT's, as outlined above, a Performance Score (P Score) is calculated by assigning points according to the P Score method (explained below). Multiple evaluators will all arrive at the same score, for a given report, because individual judgment is not called for, e.g., either an EPO was obtained, and thus earns a point--or not, and so on. Aggregation of scores permits evaluation of an individual officer's investigative habits. Aggregated data can also be used to evaluate police organizations. Ratios of use of individual OIT's are also calculated from aggregated data. The method can be carried out using a spreadsheet. This invention solves a significant problem in criminal justice, that being the previous inability of police supervisors and agencies to quantitatively and reliably assess the adequacy of individual domestic violence investigations, and also to identify officers who habitually conduct insufficient DV investigations. This invention provides an academically and legally defensible method for doing so.

### DETAILED DESCRIPTION OF THE INVENTION

A value of “1” is recorded each time one of five non-charge OIT's are found to have been operationalized, those being:
If an emergency protective order was obtained.
If photographs were obtained.
If witnesses were located.
If the defendant was arrested.
If the written report was completed the same day as the investigation.

The number of charges listed is the score given for that OIT category; thus, if one charge is listed, one point is given, if two charges are listed, two points are given, and so on. Because it is possible none of the non-charge OIT's will be operationalized, but because at least one crime code is always listed in a crime report, the range of P Scores is ≧1.

TABLE 1
Example of P Score Calculation.

| | | Police Controlled Optional Investigative Actions | | | | | | |
|---|---|---|---|---|---|---|---|---|
| Investi- | Case | Wit- | Pho- | | Ar- | | N^{o} | P |
| gator | N^{o} | ness | to | EPO | rest | CSD | Charges | Score |
| Officer | 1712 | 0 | 1 | 1 | 0 | 0 | 1 | 3 |
| # 377 | 5851 | 1 | 1 | 1 | 0 | 1 | 1 | 5 |
| | 4678 | 0 | 0 | 0 | 1 | 1 | 2 | 4 |
| | 4155 | 0 | 0 | 1 | 1 | 1 | 2 | 5 |
| | Mean | .25 | .50 | .75 | .50 | .75 | 1.50 | 4.25 |
| Officer | 1898 | 0 | 0 | 0 | 0 | 0 | 1 | 1 |
| # 137 | 4233 | 0 | 1 | 0 | 0 | 1 | 1 | 3 |
| | 9354 | 0 | 0 | 0 | 1 | 1 | 2 | 4 |
| | 1856 | 1 | 0 | 0 | 0 | 1 | 1 | 3 |
| | Mean | .25 | .25 | .00 | .25 | .75 | 1.25 | 2.75 |

Table 1 provides eight examples of how P Scores are calculated for individual police reports, how aggregated data is used to determine average P Scores, by officer, how frequencies of use are also determined from aggregated data, per officer, for the five non-charge OIT's, and finally how a mean is determined for the number of charges listed.⁶ Using report #1712 as an example, we see that the officer did not locate additional witnesses, so a value of “0” is recorded; photographs and an EPO were obtained, so “1” is recorded for each; and because no arrest was made, and the report was not completed the same day as the investigation, those categories are marked with “0”. Only one crime was alleged, so “1” is the value for that category. Summing the numbers produces the P Score for this report, which is “3”. ⁶ These data are derived from an article I published. See Nelson 2012 for details.

Two officers are compared in Table 1. Each had four reports that were included in the study. Their average P Score is quite different; for Officer #377 is 4.25, and for Officer #137 it is 2.75. Overall, the P Score averages reveal that Officer #137 is, at least in the sample investigations, routinely more thorough in her/his work when compared to Officer #377. We see that Officer #137 did not obtain any EPO's; whereas, Officer #377 obtained them 75% of the time, and so on. Using these data Officer #137 could be identified as needing remediation training on how to locate witnesses, obtain photographs, obtain EPO's, and investigate more deeply for possible additional crimes. Officer #377 can be remediated on locating witnesses.

### VALIDATION OF THE METHODOLOGY OF THE INVENTION

Using data from my original study,⁷ I tested the P Score method for statistical reliability, to see if, in fact, it actually distinguishes between categories of officers. I did so by selecting officers with three or more DV investigative reports, then calculating mean P Scores for each police officer. I sorted officers into high, medium, and low average P Score categories, then compared the high and low groups. ⁷ I studied every domestic violence police report written by a mid-sized California police agency during the year 2007, following them for 2.5 years (N=1,810). From those reports I randomly selected n=366 investigations for collection of 242 different types of data. A study of this depth and magnitude has never been carried out before. The validation analysis for the P Score method, as discussed in this section of the patent application, is based upon analysis of those n=366 randomly selected cases.

TABLE 2
Frequency of Use of OIT's, Comparison
Between Low & High Use Officer Groups.

| Variable | LOW | HIGH | z | p |
|---|---|---|---|---|
| Find & interview | .11 | .36 | 2.70 | .003 |
| witnesses | | | | |
| Obtain photographs | .41 | .82 | 4.04 | .000 |
| Obtain an emergency | .22 | .54 | 3.05 | .001 |
| protective order | | | | |
| Find & arrest the | .32 | .56 | 2.17 | .015 |
| defendant | | | | |
| Complete same day | .65 | .79 | 1.37 | .085 |
| Number of charges | 1.35 (.40) | 1.59 (.78) | 1.70 | .045 |
| Mean P Score | 3.13 (1.36) | 4.90 (1.49) | 5.41 | .000 |

As the results in Table 2 demonstrate, the difference between group averages was significant for all six OIT's, as well as for group P Score averages. Thus, it can be concluded that this method can distinguish low, middle, and high range officers, and that the differences between the low and high range is statistically significant. I believe the P Score method is statistically and methodologically defensible. Further comparison showed that the investigations of the low group are rejected by prosecutors three times more often.⁸ ⁸ Rejection rate, low group=49%, rejection rate high group=18%, z=2.99, p<0.00. The fact that the rate of prosecution is higher than the national average reflects an aggressive prosecution policy by the Prosecutor's Office, not better than average reporting by police.

### REFERENCES

Archer, J. (1999). Assessment of the Reliability of the Conflict Tactics Scales. Journal of Interpersonal Violence 14, 1263-1289.

Sharkey, P. T. (2006). Navigating Dangerous Streets: The Sources and Consequences of Street Efficacy. American Sociological Review, 71, 826-846.

Emery, R. E. and O'Leary, K. D. (1984). Marital Discord and Child Behavior Problems in a Nonclinical Sample. Journal of Abnormal Child Psychology, 12, 411-420.

Jouriles, E. N., Barling, J., and O'Leary, K. D. (1987). Predicting Child Behavior in Maritally Violent Families. Journal of Abnormal Child Psychology, 15, 165-173.

Carroll, J. C. (1980). The Intergenerational Transmission of Family Violence: The Long Term Effects of Aggressive Behavior. In J. Howells (Ed.), Advances Family Psychiatry, Vol. II, pp. 171-181. New York: International University Press.

Murrell, A. R., Christoff, K. A., and Henning, K. R. (2007). Characteristics of Domestic Violence Offenders: Associations With Childhood Exposure to Violence. Journal of Family Violence, 22, 523-532.

Browne, A., and Bassuk, S. S. (1997). Intimate Violence in the Lives of Homeless and Poor Housed Women: Prevalence and Patterns in an Ethnically Diverse Sample. American Journal of Orthopsychiatry, 6, 261-278.

Dutton, D. G, and Hart, S. D. (1992). Evidence for Long-Term, Specific Effects of Childhood Abuse and Neglect on Criminal Behavior in Men. International Journal of Offender Therapy and Comparative Criminology, 36, 129-137.

California State Attorney General (2005). Keeping the Promise: Victim Safety and Batterer Accountability. Sacramento, Calif.

Garner J. H., and Maxwell, C. D. (2009). Prosecution and Conviction Rates for Intimate Partner Violence. Criminal Justice Review 34, 44-79.

Hinds D L (1993). Domestic Violence Documentation. Law and Order 41, 86-89.

Levie, R. C. and Ballard, L. E. (1978). Writing Effective Reports on Police Investigations. Boston, Mass.: Allyn and Bacon, Inc.

Miller, D. (1993). How to Write a Police Report. Albany, N.Y.: Delmar Publishers, Inc.

National Institute of Law Enforcement and Criminal Justice. (1977). What Happens After Arrest? A Court Perspective of Police Operations in the District of Columbia. Edited by B. Forst, J. Lucianovic, and S. Cox. Washington, D.C.: United States Department of Justice.

National Institute of Justice. (1982). Arrest Convictability as a Measure of Police Performance. Edited by B. Forst, F. Leahy Jr., J. Shirhall, H. Tyson, and J. Bartolomeo. Washington, D.C.: United States Department of Justice.

Nelson, E. L. (2012). Police Controlled Antecedents Which Significantly Elevate Prosecution & Conviction Rates in Domestic Violence Cases. Criminology and Criminal Justice, online early (available now), published issue TBD.

Stanko, E. A. (1981). The Arrest Versus the Case. Urban Life 9, 395-414.

1. A method for mathematical scoring of the content of a written police report, comprising:
(a) assignment of a fixed numerical value for each positive occurrence of specified investigative actions
(b) summing the values to determine the Performance Score for a given report
(c) averaging the Performance Scores from multiple reports to determine the average Performance Score for a given police officer
(d) using multiple reports to calculate the frequency of use of individual investigative actions for a given police officer
(e) using a sample of reports to determine the average Performance Score of a group of police officers or a police agency
(f) using a sample of reports to calculate the frequency of use of individual investigative actions for a group of police officers or a police agency
whereby said method enables assessment of investigative thoroughness of individual police officers, groups of police officers, and police agencies.
